(19) United States
(12) Patent Application Publication
(10) Pub. No.: US 2010/0000375 A1
(43) Pub. Date: Jan. 7, 2010

(54) Tamper resistant jackbolts for a tensioner

(76) Inventors: Robert C. Steinbock, Bridgeville, PA (US); Allan T. Steinbock, Pittsburgh, PA (US)

Correspondence Address: CLIFFORD A. POFF, 9800B MCKNIGHT ROAD, SUITE 115, PITTSBURGH, PA, 15237, US

(21) Appl. No.: 12/217,398

(22) Filed: Jul. 7, 2008

(51) Int. Cl. B25B 29/02; B25B 23/14; B25B 13/06

(52) U.S. Cl. 81/57.38; 81/467; 81/124.4

(57) ABSTRACT

A multi jackbolt tensioner including a jackbolt body having a plurality of holes with threads to receive jackbolts having torque receiving surfaces all disposed about the periphery of each jackbolts in a mutually non parallel relation to prevent the unauthorized application of torque or stress. The torque receiving surfaces of each bolt head are defined by vertices at the intersect of n number of unsymmetrical arranged torque receiving surfaces of a polygon, where n is an odd integer.

### CROSS-REFERENCE TO RELATED APPLICATIONS

Not applicable

### BACKGROUND OF THE INVENTION

1. Field of the Invention

The present invention relates to a tamper resistant construction to prevent unwanted torquing or losing of jackbolts in a tensioner body, and more particularly, to providing an unsymmetrical arrangement of torque receiving surfaces on a bolt head, preferably housed in a counter bore of the tensioner body.

2. Description of the Prior Art

The present invention relates to improvements to the fasteners disclosed in U.S. Pat. Nos. RE 33,490 and 6,112,396 which are typically illustrated in FIGS. 1 and 2. The fastener is used to clamp flanges 1 and 2 under a compression force indicated by arrows 3 which is maintained by stress indicated by arrow 4 in a shank portion 5.

The particular fastener illustrated in FIGS. 1 and 2 has a fastener head 6 at one end of the shank portion 5 and a tensioner body 7 threaded engaged with the shank portion opposite the fastener head 6. Torque applied to jackbolts 8 threadedly engaged about the periphery of the tensioner body 7 develop a very high thrust force against a hardened washer 9. This thrust force and the opposite reaction force on fastener head 6 create a strong clamping force on the flanges. The jackbolts are subject to very high compressive stresses. Compressive stresses in excess of 200,000 psi are routinely permitted for some materials. FIG. 3 provides a comparison of the torque required to generate 45,000 psi in the shank portion with a threaded diameter up to 6 inches. Curve A illustrates the increase to the necessary torque that must be applied to the nut of a standard bolt fastener. The torque increases in an exponentially fashion with an increase to the diameter of the threaded shank portion. Curve B illustrates the necessary torque that must be applied to the jackbolts of the fastener shown in FIGS. 1 and 2. The required torque is substantially constant with the increase to the diameter of the threaded shank portion.

The use of jackbolts in tensioner has provided great benefits of reducing the required effort and the requirements for large tools to provide a large moment arm needed to generate the large tensions required for standard type fastener bolts. The use of jackbolts reduces the torque generating requirement to such an extent only hand operated tools can be used such as standard torque wrenches or small pneumatic powered tools to generate the needed bolt tension. The use of a standard torque wrench also increases the precision and safety for obtaining the desired bolt tension. Typically, the bolt head has six uniformly distributed torque receiving surfaces about the outer periphery of the bolt head. It is also common the use socket head cap screws having a conventional arrangement of six uniformly distributed torque receiving surfaces on a rim section forming in a central cavity wherein a hexagon shaped wrench is inserted to torque the jackbolt. All of these bolt head configuration feature parallel torque receiving surfaces uniformly spaced about the periphery of the bolt head. An added benefit is realized in the saving contributing to the saving of time for the installation and the removal of the fastener. The use of jackbolts in fasteners has found great utility in many industries and allows, for example, the use for bolting applications in columns forming the frame of large forging presses; high pressure steam turbines; pinion stands; gear reducers; gear boxes; crushing equipment; military equipment; mining equipment; main steam inlet flange, control valve, generator bearing housing all used in nuclear power plants; and commercial Marine namely off shore applications. This has given rise to concerns in the present day society that persons with destructive intent might gain unwanted and unauthorized access to jackbolt tensioner used in strategically important equipment and with little effort and common tools create terrorist catastrophes. Accordingly a need exists for providing a construction and arrangement of parts to deter and preferably eliminate unauthorized torquing or loosening of jackbolts in a jackbolt tensioner.

Accordingly it is an object of the invention to provide a multi jackbolt tensioner wherein the jackbolts thereof include a tamper resistant torque receiving bolt head.

It is a further object of the present invention to provide a unique construction and arrangement of torque receiving surfaces and parts and parts associated therewith for a multi jackbolt tensioner wherein the torque receiving surfaces are all disposed in a non parallel relation to prevent the application of torque or release of stress generated thereby through the use of conventional hand held tools and torque generation implements.

It is another object of the invention to provide a multi jackbolt tensioner wherein the torque receiving surfaces of the jackbolts thereof have bolt heads defined by vertices at the intersect of n number of unsymmetrical arranged torque receiving surfaces of a polygon, where n is an odd integer.

It is a further object of the present invention to provide a unique construction and arrangement of torque receiving surfaces and parts associated therewith for a multi jackbolt tensioner wherein the torque receiving surfaces are all disposed in counter bored extensions to the threaded bores in a jackbolt body and further that the torque receiving surfaces in a non parallel relation with one another to prevent the application of torque or release of stress generated thereby through the use of conventional hand held tools and torque generation implements

### SUMMARY OF THE INVENTION

The present invention provides a multi jackbolt tensioner including a jackbolt body having a plurality of holes spaced uniformly from a longitudinal central axis at spaced apart locations about an outer periphery thereof, the holes having sidewalls formed with body threads, and jackbolts each including a jackbolt body having jackbolt threads to threaded engage the body threads in one of the holes in the jackbolt body, the jackbolts further including torque receiving surfaces all disposed about the periphery of each jackbolts in a mutually non parallel relation to prevent the unauthorized application of torque or stress removal.

Preferably the torque receiving surfaces on each bolt head are defined by vertices at the intersect of n number of unsymmetrical arranged torque receiving surfaces of a polygon; where n is an odd integer. A further embodiment provides an arrangement of a plurality of curvilinear torque receiving surfaces all in a non parallel relation.

### BRIEF DESCRIPTION OF THE SEVERAL VIEWS OF THE DRAWINGS

The present invention will be more fully understood when the following description is read in light of the accompanying drawings in which:

FIG. 1 is an isometric view illustrating a multi jackbolt tensioner of the type known in the art and illustrated in U.S. Pat. Nos. RE 33,490 and 6,112,396;

FIG. 2 is an elevational view in section illustrating the jackbolt threadedly engaged with a threaded opening in a tensioner body before applying torque to the jackbolt;

FIG. 3 is a graph comparing torque requirement for generating bolt stress in a convention bolt fastener and in a fastener using jackbolts;

FIG. 4 is an elevational view in section illustrating the tamper resistant jackbolt according to one embodiment of the present invention threadedly engaged with a threaded opening in a tensioner body;

FIG. 5 is a view taken along lines V-V of FIG. 4;

FIG. 6 is an enlarged view of the bolt head and part of the adjoining threaded portion of the tamper resistant jackbolt shown in FIGS. 4 and 5;

FIG. 7 is a sectional view taken along lines VII-VII of FIG. 6;

FIG. 8 is a sectional view through a socket head bolt head illustrating a pentagon arrangement of torque receiving surfaces;

FIG. 9 is a sectional view through a bolt head illustrating an irregular pentagon arrangement of torque receiving surfaces; and

FIG. 10 is a sectional view through a bolt head illustrating an arrangement of curvilinear torque receiving surfaces.

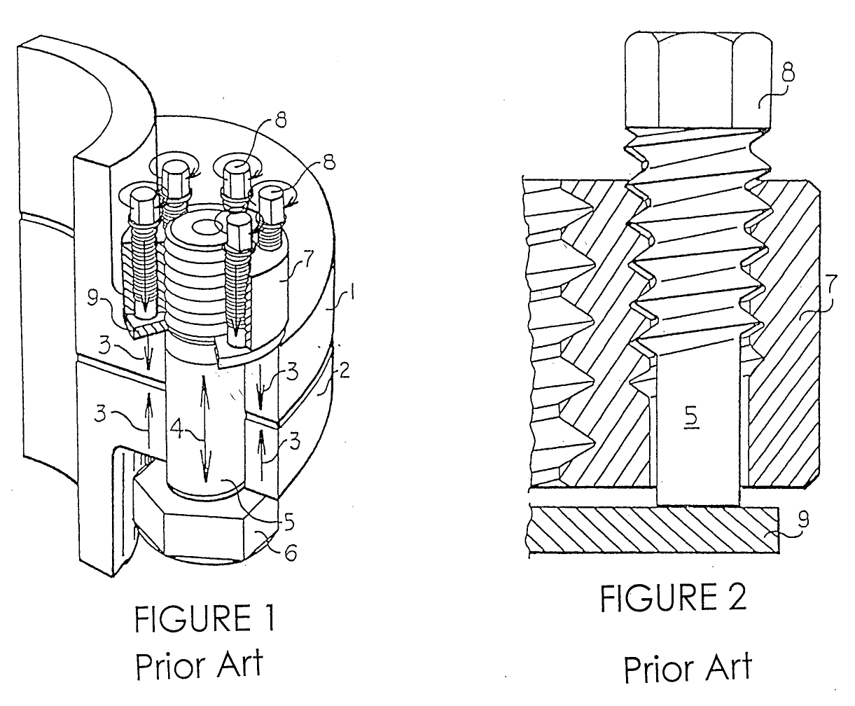

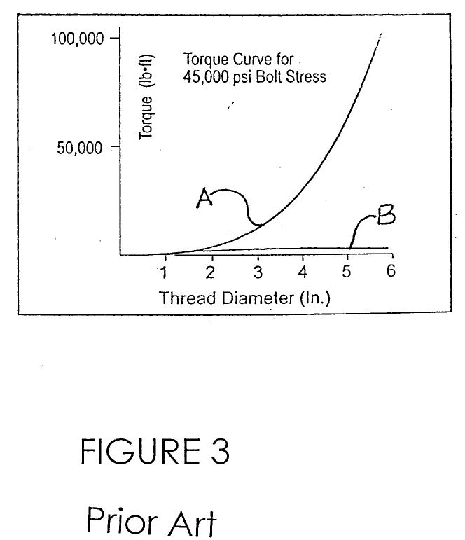

### DETAILED DESCRIPTION OF THE INVENTION

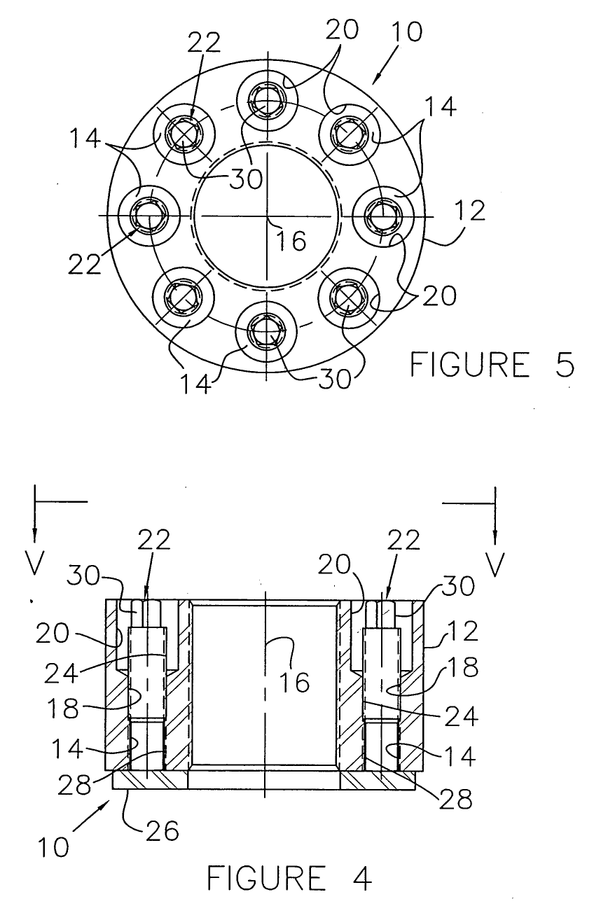

FIGS. 4 and 5 illustrate a multi jackbolt tensioner 10 including a jackbolt body 12 having a plurality of holes 14 spaced uniformly from a longitudinal central axis 16 at spaced apart locations about an outer periphery of the jackbolt body. The preferred embodiment of the present invention provides that the holes 14 comprise a first length of sidewall with thread 18 and a second length of sidewall comprising a counter bore 20. The holes 14 are each provided with a jackbolt 22 having a threaded portion 24 engaged with the thread 18. A terminal end portion 28 of each jackbolt 22 extends from the thread portion 24 a distance sufficient to protrude from the jackbolt body and into engagement with a washer 26 or other stress receiving element of the bolted parts. The terminal end portion 28 can comprise a continuation of the threaded portion 24, if desired.

FIGS. 4-7, illustrate the jackbolt head 30 is constructed according to the present invention with torque receiving surfaces 32 all disposed about the periphery of each jackbolt in a mutually non parallel relation to prevent the unauthorized application of torque or stress removal.

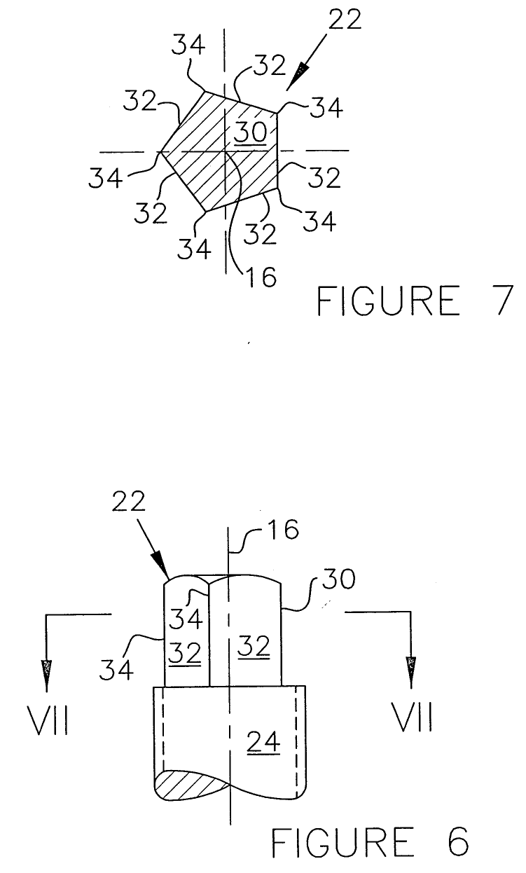

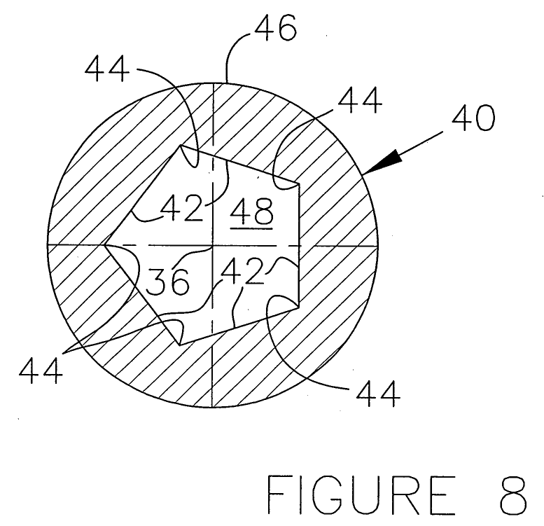

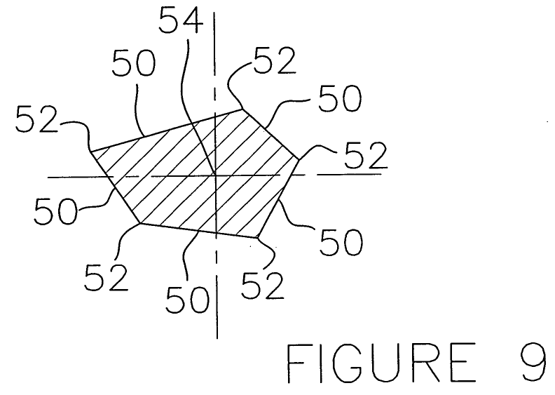

Preferably, the torque receiving surfaces 32 will reside in the counter bore 20 below the exposed face surface 12A of the a jackbolt body 12 as the jackbolt advances along the thread 18 until torque to the desired value. The diameter of the counter bore 20 is selected to protectively house the torque receiving surfaces 32 and also allow unimpeded entrance of hand held tools or torque generation implements. This arrangement offers the advantage of restricting access to the torque receiving surfaces since the torque receiving surfaces confront the sidewalls formed by the counter bore 20 in the jackbolt body. According the depth of the counter bore may exceed the height of the torque receiving surfaces to thereby allow a range of movement of the jackbolts without exposing the torque receiving surfaces. It is imperative that tamper resistant torque receiving surfaces are disposed about the bolt head so that there are no mutually parallel torque receiving surfaces to the application of an apposed griping force to either apply tension or release stress developed by the jackbolts. As shown in FIGS. 6 and 7, the torque receiving surfaces 32 are defined between vertices 34 at the intersect of n number of unsymmetrical arranged torque receiving surfaces of a polygon; where n is an odd integer. In the embodiments of FIGS. 4-7 and FIG. 8 the integer is 5 thereby defining a pentagon configuration In FIGS. 4-7 the vertices 34 are equally spaced from the longitudinal central axis 16. In FIG. 8, a section through the socket head 40 is illustrated wherein the torque receiving surfaces 42 are defined between vertices 44 and equally spaced from the longitudinal central axis 36. The surfaces 42 are formed in a rim section 46 and receive torque by inserting a suitably shaped wrench in the socket head cavity 48.

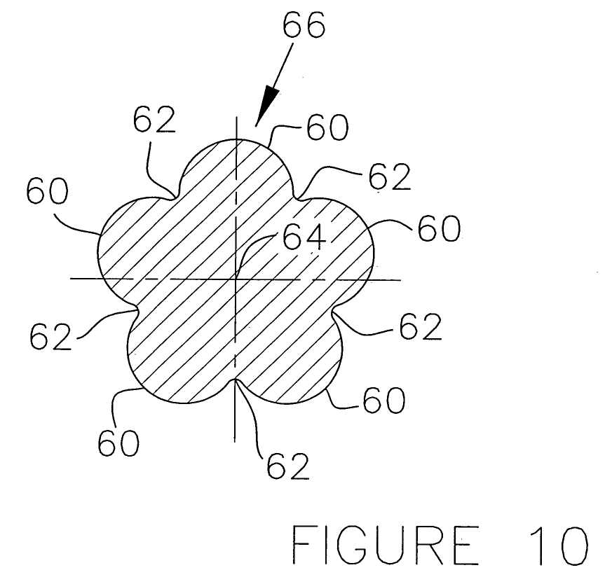

The polygon can be irregular as shown by the sectional view of FIG. 9. The irregular configuration of torque receiving surfaces 50 in the polygon is notable by the irregular distancing of the vertices 52 from the longitudinal central axis 54. In addition to the preferred number of five torque receiving surfaces, the torque receiving surfaces may belong to the group of polygons where the number of unsymmetrical arranged torque receiving surfaces are, for example, 3, 7, 9 or 11. The number of such torque receiving surfaces is likely to increase the complexity for forming and using the tool or implement to install and remove the jackbolt tensioner.

FIG. 10 illustrates a further embodiment of the present invention having a distinctive characteristic feature of a plurality of curvilinear torque receiving surfaces 60 separately by adjoining reversely curved filets 62 disposed about the periphery of the head portion of the jackbolts. In FIG. 10, the outer periphery is constructed with five curvilinear torque receiving surfaces 60 having the form of circular sectors. Other suitable curvilinear forms include any one or a mixture of: two centered compound cures; three centered compound curves; a hyperbola; and a parabola. The longitudinal central axis 64 demonstrates the non parallel relation between oppositely directed sites at the outer periphery o the bolt head 66.

While the present invention has been described in connection with the preferred embodiments of the various Figures, it is to be understood that other similar embodiments may be used or modifications and additions may be made to the described embodiment for performing the same function of the present invention without deviating therefrom. Therefore, the present invention should not be limited to any single embodiment, but rather construed in breadth and scope in accordance with the recitation of the appended claims.

1. A multi jackbolt tensioner including:
a jackbolt body having a plurality of holes spaced uniformly from a longitudinal central axis at spaced apart locations about an outer periphery thereof, said holes having sidewalls formed with body threads, said holes having sidewalls formed with body threads;
jackbolts each including a jackbolt body having jackbolt threads to threadedly engage said body threads in one of the holes in said jackbolt body, said jackbolts further including torque receiving surfaces all disposed about the periphery of each jackbolts in a mutually non parallel relation to prevent the unauthorized application of torque or stress removal.

2. A multi jack bolt tensioner according to claim 1 wherein said torque receiving surfaces confront said sidewalls of said jackbolt body.

3. A multi jack bolt tensioner according to claim 2 wherein said jackbolt body is further defined by a counter bore extending to each of said body threads for receiving said torque receiving end of said jackbolts.

4. A multi jack bolt tensioner according to claim 1 wherein said jackbolt body is further defined by a counter bore extending from a face surface of said jackbolt body to each of said plurality of holes said body threads for receiving a said tamper resistant torque receiving bolt head.

5. A multi jack bolt tensioner according to claim 4 wherein said counter bore confronts said torque receiving surfaces at a spaced apart relation

6. A multi jack bolt tensioner according to claim 1 wherein said torque receiving surfaces are curvilinear.

7. A multi jack bolt tensioner according to claim 1 wherein said torque receiving surfaces are have a curvilinear form selected from the group consisting of circular sectors; two centered compound cures; three centered compound curves; a hyperbola; and a parabola.

8. A multi jackbolt tensioner including:
a jackbolt body having a plurality of holes spaced uniformly from a longitudinal central axis at spaced apart locations about an outer periphery thereof, said holes having sidewalls formed with body threads, said holes having sidewalls formed with body threads;
jackbolts each including a jackbolt body having jackbolt threads to threadedly engage said body threads in one of the holes in said jackbolt body, said jackbolts further including a tamper resistant torque receiving bolt head comprising vertices at the intersect of n number of unsymmetrical arranged torque receiving surfaces of a polygon, where n is an odd integer.

9. A multi jack bolt tensioner according to claim 8 wherein said polygon is regular and said odd integer is five.

10. A multi jack bolt tensioner according to claim 8 wherein said polygon is irregular and said odd integer is five.

11. A multi jack bolt tensioner according to claim 10 wherein said torque receiving surfaces confront said sidewalls of said jackbolt body.

12. A multi jack bolt tensioner according to claim 11 wherein said jackbolt body is further defined by a counter bore extending to each of said body threads for receiving said torque receiving end of said jackbolts.

13. A multi jack bolt tensioner according to claim 12 wherein said jackbolt body is further defined by a counter bore extending from a face surface of said jackbolt body to each of said plurality of holes said body threads for receiving a said tamper resistant torque receiving bolt head.

14. A multi jack bolt tensioner according to claim 13 wherein said counter bore confronts said torque receiving surfaces at a spaced apart relation.
